(19) United States
(12) Patent Application Publication
(10) Pub. No.: US 2017/0278053 A1
(43) Pub. Date: Sep. 28, 2017

(54) EVENT-BASED SALES PREDICTION

(71) Applicant: Wal-Mart Stores, Inc., Bentonville, AR (US)

(72) Inventors: Donald High, Noel, MO (US); Michael Dean Atchley, Springdale, AR (US); Henry Sampara, Bentonville, AR (US)

(21) Appl. No.: 15/465,698

(22) Filed: Mar. 22, 2017

Related U.S. Application Data
(60) Provisional application No. 62/311,768, filed on Mar. 22, 2016.

(51) Int. Cl. G06Q 10/08; G06Q 30/02

(52) U.S. Cl. CPC G06Q 10/087; G06Q 30/0202

(57) ABSTRACT

A system identifies statistically significant variation in sales volume in response to occurrence of an event as well as attendant factors relating to the event. Past events of the same type are identified that fit into one or more categories. The sales data for these past events are aggregated and any statistically significant variation due to the one or more selection criteria can be identified. A forecasting model is then updated to include the one or more categories as factors impacting sales volume. Examples of events include planned events such as holidays and sporting events and unplanned events such as extreme weather or other natural disasters.

### RELATED APPLICATION

The present application claims the benefit of U.S. Provisional Application No. 62/311,768, filed Mar. 22, 2016, the contents of which are hereby incorporated in their entirety by reference.

### TECHNICAL FIELD

Embodiments relate to systems and methods for analyzing past sales data to predict future sales.

### BACKGROUND

Many retailers seek to predict future sales so that inventories can be maintained at an appropriate level in order to avoid missing opportunities or having to store unsold products. Often seasonal variation in sales is evident. Likewise, certain events may result in sales spikes or declines. Some events such as holidays and sporting events are predictable and repeated. Other events, such as extreme whether, is not as predictable or repeated. In any case, in order to take advantage of increases in demand or avoid losses due to unexpected lack of demand, a retailer will seek to predict sales as accurately as possible.

The systems and methods disclosed herein provide an improved approach for predicting sales of a product in response to events.

### SUMMARY

According to an embodiment, a method for monitoring real-time data to manage inventory includes monitoring a plurality of real-time data sources to detect an upcoming event, and matching the detected upcoming event to one or more categories. The method further includes retrieving, from a database, static data corresponding to each of the one or more categories that matches the detected upcoming event. The static data can be based upon sales data related to at least one past event. The method further includes stacking the retrieved static data from each of the matched categories to generate a forecast for the detected upcoming event, and comparing the forecast and an existing inventory to generate a task with an inventory management module.

In another embodiment, a system for monitoring real-time data to manage inventory comprises one or more processors and one or more memory devices coupled to the one or more processors. The one or more memory devices store executable code effective to cause the one or more processors to monitor a plurality of real-time data sources to detect an upcoming event, match the detected event to one or more categories, and retrieve, from a database, static data corresponding to each of the one or more categories that matches the detected upcoming event. The static data can be based upon sales data related to at least one past event. The system is further configured to cause the processors to stack the retrieved static data from each of the matched categories to generate a forecast for the detected upcoming event, and compare the forecast and an existing inventory to generate a task with an inventory management module.

### BRIEF DESCRIPTION OF THE DRAWINGS

Subject matter hereof may be more completely understood in consideration of the following detailed description of various embodiments in connection with the accompanying figures, in which:

FIG. 1 is a schematic block diagram of a network environment suitable for implementing embodiments of the invention;

FIG. 2 is a schematic block diagram of an example computing device suitable for implementing methods in accordance with embodiments of the invention;

FIG. 3 is a process flow diagram of a method for identifying statistically significant criteria affecting sales in a period including an event in accordance with an embodiment of the invention;

FIG. 4 is a graph illustrating the stacking of sales data for events meeting one or more selection criteria in accordance with an embodiment of the present invention; and

FIG. 5 is a process flow diagram of a method for forecasting sales using a forecasting model in accordance with an embodiment of the present invention.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Embodiments described herein include systems and methods for estimating, in real time, the effects of an event on demand for a variety of products. Based on the output of the system, changes in orders for inventory can be made or products can be moved to closely match the anticipated demand based on the event. In embodiments, the system can automatically manage orders for products or inventory, or notify a store manager or purchaser that there is a need to modify existing orders.

Systems and methods described herein can anticipate an increase or decrease in demand based on an event, and assist a retailer in matching inventory to that demand. Weather patterns, holidays, and events cause measurable increases or decreases in sales of associated goods, and failure to anticipate and properly react to such events can leave a retailer with either too little or too much of a given product. Too little of a product can cause a retailer to lose sales during times when it is out of stock, whereas too much of a product can cause losses due to required markdowns, as well as use of valuable shelf or storage space.

Embodiments described herein provide insight into not only how much of a certain product will be needed based on a particular event, but also when it will be needed. These insights can be used to modify orders placed by the store such that necessary quantities of inventory are available when needed, while also avoiding orders of excess inventory. Embodiments also help a store avoid orders for shipments that would occur too late, after the demand peak associated with a certain item and a certain event have already passed. Using machine learning, estimates of the timing and amplitude of product demand changes based on various types of events can be constantly improved. Likewise, real-time monitoring of large amounts of data related to existing or upcoming conditions by a computer system, processor or other device can improve the estimates of product demand produced by embodiments to give up-to-date analysis and recommendations to inventory managers. In embodiments, a large number of real-time data sources can be monitored simultaneously, such that a system can provide up-to-date forecasts based on new information in any of a variety of categories.

In embodiments, various computerized systems are configured to manage large quantities of real-time data. For example, in embodiments computerized systems could simultaneously monitor weather, traffic, breaking news at a local, regional, national, and/or international level, as well as trends and real-time shopping data. These large quantities of real-time data can be collected and analyzed, either separately or in combination, to detect events more rapidly and accurately than relying on conventional methods for forecasting inventory requirements. Furthermore, embodiments can track interrelations or interactions between various effects, such as fashion trends, weather, or local events, which can have different effects in combination than they would in isolation. Using machine learning and very large quantities of data, embodiments described herein can rapidly generate accurate forecasts for inventory needs based on stored data relating to statistically significant events in the past.

The embodiments described herein will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

Embodiments are described below with reference to flowchart illustrations and/or block diagrams of methods, apparatus (systems) and computer program products according to embodiments of the invention. Each block of the flowchart illustrations and/or block diagrams, and combinations of blocks in the flowchart illustrations and/or block diagrams, can be implemented by computer program instructions or code in embodiments. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

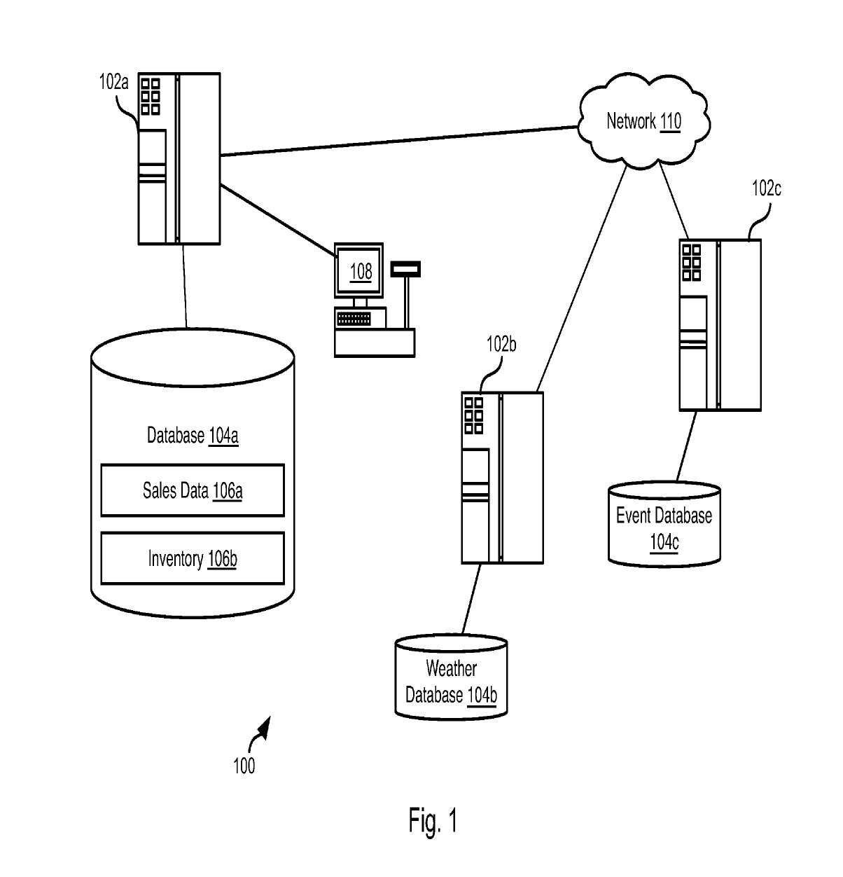

Referring to FIG. 1, a network environment 100 may be used to implement methods as described herein. The environment 100 may include a server system 102a associated with a corporate parent or controlling entity having one or more retail establishments associated therewith. The server system 102a may host or access a database 104a including sales data 106a describing past sales of a product. The past sales data may be a list of every transaction for each product or may be a result of processing such data. For example, the past sales data 106a may be analyzed to calculate a sales volume for each product at each retail location, online portal, warehouse store, or other facility operated by a retailer. Sales data 106a may include sales volume values that each indicate an amount of sales of a particular product in a particular geographic location (neighborhood, county, city, state, country, etc.).

The database 104a may also store an inventory 106b storing some or all of the current amounts of each product at each of a plurality of facilities (retail locations, warehouses, distribution centers), pending orders and expected delivery dates for each product, and a schedule describing when to place orders for each product of a particular product through out a time period (e.g. year, quarter, or other interval).

The sales data 106a may be reported to the server system 102a by point of sale devices (POS) 108 on which transactions may be concluded. The POS 108 may also be part of an e-commerce system. The e-commerce system may include, for example, a web-application that permits customers to purchase various products and/or services over the Internet. POSs 108 in communication with the server system 102a may include POSs 108 associated with a warehouse store that is a separate entity or format than the retail establishments.

The server system 102a may be in data communication with one or more servers 102b, 102c that host or access databases 104b, 104c describing events that may have an impact on sales. For example, weather database 104b may record historical weather data for a plurality of locations, such as quantity of precipitation, type of precipitation (rain, snow, hail), the date of occurrence and severity of extreme weather events (hurricanes, blizzards, monsoon rains, etc.), daily temperatures, daily humidity, and the like. The weather database 104b or another database may include predictions relating to some or all of these weather events and attributes as well. A database 104c may record a date and description for other events such as sporting events, political events (elections), cultural events, holidays, natural and manmade disasters, and the like.

The server systems 102a may be in data communication with the server systems 102b, 102c, and POSs 108 by means of a network 110. The network 110 may include any wired or wireless connections and may include some or all of a local area network (LAN), wide area network (WAN), the Internet, or other type of network.

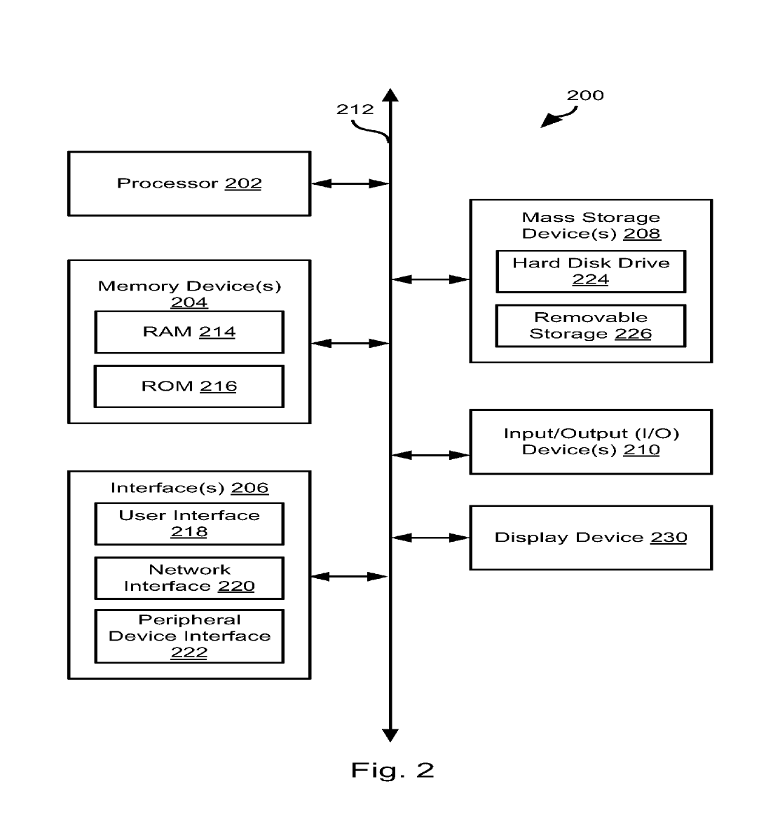

FIG. 2 is a block diagram illustrating an example computing device 200. Computing device 200 may be used to perform various procedures, such as those discussed herein. The server systems 102a, 102b, 102c and POS 108 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, a tablet computer and the like. A server system 102a may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

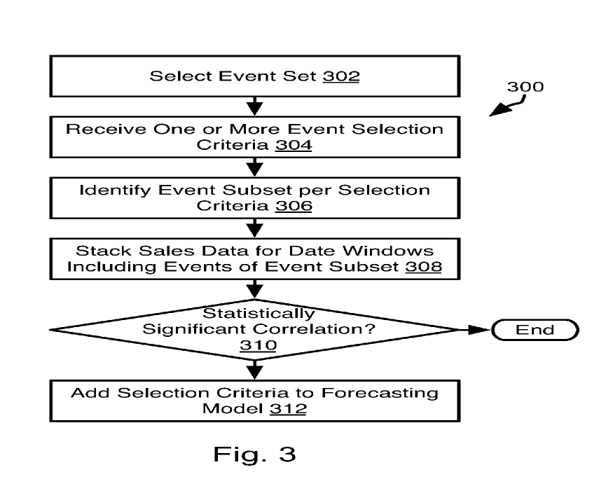

Turning now to FIG. 3, the illustrated method 300 may be executed by the server system 102a with respect to sales data 106a for each product of a plurality of products. Accordingly, the method 300 may be executed for each product of a plurality of products. The method 300 may also be executed for each event of a plurality of events.

The method 300 may include selecting 302 an event set. The event set may include selecting set of past occurrences of the same type of event, e.g., a set of dates that all correspond to past occurrences of the same holiday, the same type or severity of weather event (blizzard, torrential rain, ice storm), the same type or severity of a natural disaster (earthquake, forest fire, drought, flood power outage), the same type of sporting event, or the same occurrence of a sporting event (e.g., the Super Bowl). Other examples of events can include one or more global events, national events, regional events, or local events.

Global events include, but are not limited to, religious holidays, conflicts, remembrances of the anniversaries of events, or worldwide sporting events such as the Olympics or World Cup. Other worldwide events include, for example, days of the week (e.g., sales of certain products may vary between weekends and weekdays) or month (e.g., sales on the first of each month may be different than sales mid-month). Global events can further include innovations which change demand for a product, such as the introduction of an improved line of electronics or the discontinuation of an older line of products.

National events include, but are not limited to, national news, government announcements, voting schedules, military activity, government regulations, national holidays, proclamation days, release of video or music or the opening day of a movie in theater, retail sale, or broadcast, professional sport events, tournaments, or races, charity events, awareness campaigns relating to various issues or diseases, national disasters or tragedies, or political actions or activities. The effect of national events on sales of particular products can also be regional or local, such as where a professional sports team is playing in town, the rating or popularity of that team, or whether the particular game is a special event such as a SuperBowl game. Likewise, the scope of an effect can be modified by real-time data such as the reported receipts for a newly-released movie.

Regional events include, but are not limited to, regional news, college or professional sports games and event schedules, car shows, boat shows, home shows, bicycle tours, motorcycle tours, the start and end dates of hunting or fishing seasons in a particular region, daylight savings time, a local show such as a rodeo, circus, fair, festival, or fireworks display, the payday schedule for regional employers to distribute paychecks, bonuses, tax refunds or rebates, tax free week, or incentive checks, concerts, airfare price changes, threat level assessments, or anything else that could affect savings or costs in a particular region. Other regional events can include conventions, business hours of regional malls, grocery stores, or employers, park openings or closings, or local swimming pool or other recreation center hours and schedules.

Local events include, but are not limited to, local news, children's sports of recreation schedules or league schedules, adult sport recreation schedules or league schedules, school activities such as start, end, or breaks, college and professional sporting events such as home games (modified by team popularity, rivalries, and fan base size), a local parade, social event, civil/union/fraternal organization activity, road work or traffic pattern or disruption. Local events can also include start or stop of local summer camps, or religious school sessions or camps or activities. Local events can include the effects of local, regional, or even national strikes or picketing relating to particular stores or boycotts of certain products or brands. Local events can include terrain or geography (e.g., some roads or areas may be attractive tourist destinations at times, or inaccessible during certain seasons), tourism, or cultural events.

In addition to events, certain regional or even store-specific conditions can affect sales of particular products or types of products. Examples of regional conditions include, but are not limited to, fire or smoke or smog. Floods or rainfall can cause mud, pests, or dampness that require additional cleanup supplies. Electrical failure can affect demand for lighting, heating, hot water supplies, cooking supplies, or entertainment. During certain weather conditions demand for products related to indoor activities increases, while during certain other weather conditions demand for products related to outdoor activities increases. Regional weather patterns can increase demand for plant or lawn growth products, watering supplies, or lightning protection such as surge suppressors, lighting rods, or generators. Local effects can be more long-term, such as years of La Niña or El Niño weather patterns. Weather or climate patterns, weather short- or long-term, can impact demand for insect-related or rodent-related pest control products, or products that affect allergens, pollen, mold spores, viruses, or dust. Natural phenomena such as solar or lunar activity, ocean tide information, wave data, ocean temperature data, lake water temperature, or lake depth can also constitute a regional or local condition. Nearby companies going out of business or new business openings can also be a regional or local condition.

Local conditions can include local weather highs, lows, or even real-time data. Sunrise and sunset times can also be included in local conditions. Local conditions can include, but are not limited to, precipitation such as rain, snow, sleet, or hail, as well as related conditions such as fog, visibility, or ice. Local conditions can include wind speed (either consistent, gusts, or both). Local conditions can include local severe weather including hurricanes or tornadoes, as well as changes in water purity, pollutants to local air or water, school closings, evacuations, or crime.

Store-specific events, conditions, and facts can also be used to determine demand for products according to embodiments. For example, these can include the level of on-hand products, or conversely products which are out of stock, whether a store has recently opened or changed hours, demographics around the store, technology sophistication at the store, promotions, store age, whether the store is closed during normal hours, a number of available parking spaces, a number of registers available, or a distance to a sport stadium, military base, competition, school, swimming area, or park. Store-specific events can include types of use of an associated parking lot, such as car washes, RV parking, or promotional or market-style events held in parking lots. Store-specific events can also include celebrity appearances, store type, a number of store associates or details regarding the level of experience, number of stores per person in the local area, or the details regarding the available equipment at the store. Other store-specific facts can include the customer service score of the store, overstock or understock levels, shrink statistics, perceptions regarding the store, associate engagement scores, store sustainability, and store expenses.

Demand for specific products can also be driven by trends, which can be local, regional, national, or international. Trends include, but are not limited to, clothing fads or styles, economic indicators, technological changes, population changes, demographic shifts, or local habits. Economic indicators can include housing statistics, unemployment rates, interest rates, layoffs or hiring, stock market prices, commodity futures, currency exchange rages, social media data, or inflation rates. Local habits can include smoking data or beverage or other preferences of a certain area, for example.

Capacity constraints can also affect demand and supply for a product or type of products. Capacity constraints can include, but are not limited to, product saturation, aisle width, shelf capacity, size of a stockroom, local laws that prohibit sales of a certain item or type of item, building codes, and entrances to the parking lot or store, for example.

The examples above are not intended to be limiting, but rather they include only some of the types of data that can be measured when selecting an event 302 and determining an effect of that event on expected sales. Possible sources of such data can include Collaborative Planning, Forecasting and Replenishment (CPFR) data, a store survey system, one or more retail analytics systems, Internet monitoring such as social media data, information published in a newspaper, a farmers' almanac, government publications, news services, periodicals, manual data entry, store energy use measurements, feature tracking, markdown management, and determinations of price elasticity, among others.

The method 300 may include receiving 304 one or more event selection criteria such as those described above. Step 304 may include receiving the selection criteria from a human operator or retrieving the one or more event criteria from a set of predefined event selection criteria. For example, the method 300 may be performed one with respect to each of the event selection criteria in the set as well as some or all possible combinations of two, three, or more of the event selection criteria in the set. Examples of event selection criteria may include the day of the week on which the event occurred, the type of weekday (weekend vs. non-weekend days), the season when the event occurred, the weather conditions (temperature, precipitation, humidity, cloud cover, etc.) when the event occurred, season in which the event occurred, whether school was in session, whether a scheduled school break is occurring, or any other attribute of the day on which an event occurred or any other event that may co-occur on the same day as the event or within some window of days including the event.

The method 300 may further include identifying 306 an event subset from the event set that satisfy the one or more event selection criteria. For example, where the event is a holiday such as Valentine's Day and the selection criteria is a day of the week (e.g. Wednesday), then the event set will be a list of dates of past occurrences of Valentine's Day that fell on a Wednesday within some time cutoff, e.g. the last five years, 10 years, or some other limit.

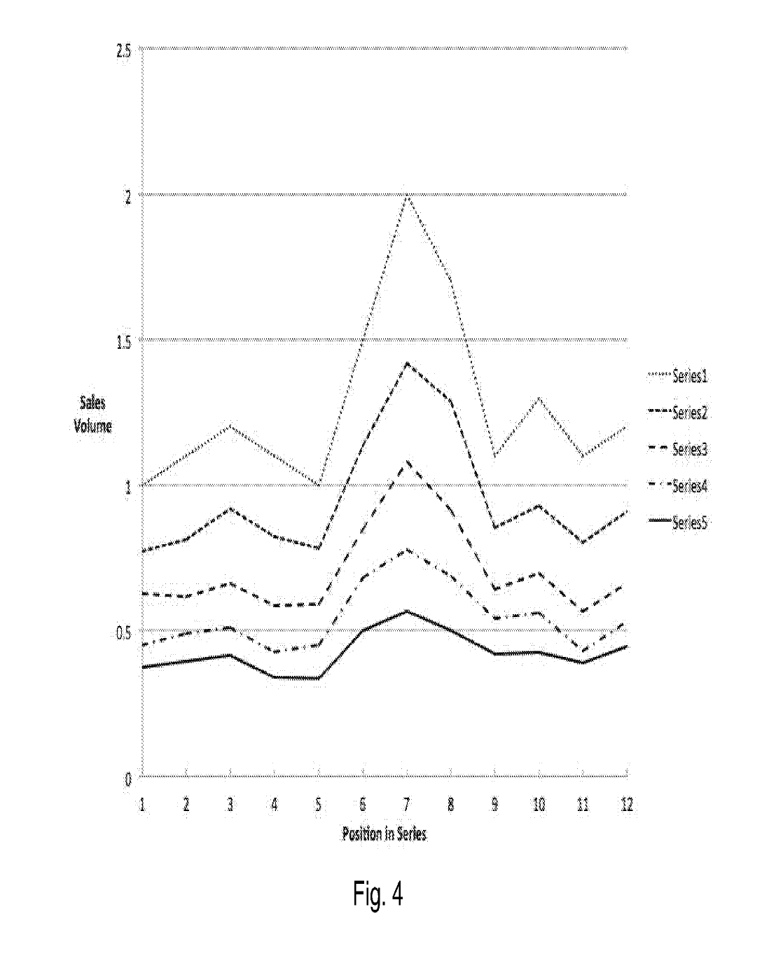

The method 300 may further include stacking 308 sales data for date windows including one of the events of the event set. For example, referring to FIG. 4, in the illustrated example, series 1 may include sales data for the product in a 12 day period including one event of the event subset, series 2 includes sales data for a 12 day period including a different event of the event subset, and so on up to series 5 or any number of events. The position of the event from the event subset in each date window may be the same for each event, e.g. the Lth date each date window, where L is any value from 1 to M, where M is the number of dates in each date window.

Stacking 308 may then include summing the sales data for each position in the sales window. Thus, the sales data for the date in position 1 for all the date windows will be summed to obtain a first aggregate value, the sales data for the date in position 2 for all the data windows will be summed to obtain a second aggregate value, and so on up to the last date in the date window (the 12th date in the example of FIG. 4).

According, for a window of length M, M aggregate values A(i), i=1 to M will be output from the stacking step 308. The stacking process may be summarized mathematically as follows:
for each date d(i), i=1 to N, in the event subset including N dates, a date window of M dates W(i,j), j=1 to M, is defined such one of the dates in the window W(i,j) includes the date d(i) at a particular position j=L, where L is a value from 1 to M.
   For each position j=1 to M in the date windows W(i,j), calculate an aggregate value A(j) as a function of sales data on all dates W(i,j), i=1 to N, e.g. A(j)=Σᵢ₌₁^{N}S(i, j), where S(i,j) is the sales data for the product on the date in position j of the window W(i,j).

In one example, stacking 308 can include one or more weather effects. Method 300 can determine, in real time, what is selling more quickly or less quickly than expected based upon static data. The static data relied upon in method 300 can include, for example, comparisons to data for sales of the same product under various conditions. For example, real-time data relating to sales of a product can be compared to other sales located in the same physical store, or at the same type of store location (e.g., end cap or alley). The static data can further be filtered according to the existence or absence of any of the other events described above, among others.

For a weather-related example, real-time data of shovel sales during the first snowfall of a winter season can be compared to static data relating to shovel sales during the first snowfall of previous winter seasons. Conversely, when high temperatures reach 80° for the first time after winter, products such as pool items, pool chemicals, pool toys, sandals, sunglasses, grills, and patio furniture may increase, while sales of snow shovels would decrease.

The method 300 may then include evaluating 310 whether the series of aggregate values A(j), j=1 to M, indicates a statistically significant correlation. In many instances, the occurrence of the event will be known have a statistically significant effect on sales. Accordingly, determining whether there is a statistically significant correlation may include determining whether the one or more event selection criteria have a statistically significant impact on the sales data.

For example, the aggregate values A(j) may be averaged (divided by the number of events in the event set) to obtain average aggregate values a(j). This series of values a(j) may then be compared to a series b(j) that is obtained by stacking (per the method of step 308 and FIG. 4) some or all events of the event set that either exclude or are not exclusive to events satisfying the one or more event selection criteria for date windows of identical size and having the events of the event set at the same position in the date windows as was used for step 308. For example, if the series a(j) indicates a sales spike in position j=3, whereas series b(j) does not include such a sales spike at j=3, then the one or more event selection criteria may be deemed to be statistically significant. Any statistically significant variation among the data of the series a(j) with respect to the series b(j) may be identified, including sales declines. Whether a sales increase or sales decrease for a particular position in a(j) is statistically significant relative to the same position in b(j) may be a function of the relative increase or decrease for the same position in b(j), e.g. an increase or decrease of at least 5%, or some other predetermined percentage.

If the one or more event selection criteria are found 310 to correlate to a statistically significant variation in sales, then the one or more event selection criteria may be added 312 to a forecasting model. For example, where the event falls on position j=P within the date window of step 308, and a statistically significant variation is determined to occur at position j=P+Q, where Q is positive or negative depending on the whether the variation occurs after or before the event, then the forecasting model may be modified to predict a corresponding variation in sales Q days after or before an event corresponding to the event selected at step 302 and having the one or more event selection criteria from step 304 will occur.

For example, a prediction function may be of the form V(j, C1, C2, . . . CD)=f0(j)+f1(j,C1) . . . +fD(j,C1). V may be a predicted sales volume and j is a position within a date window including the selected event (step 302) at the position within the date window used throughout the method 300. The function f0(j) may be a base prediction function that approximates sales volume for the sales window including the event, e.g. based on a curve fit of average sales volume b(j) for date windows including occurrences of the that exclude or are not exclusive to occurrences of the event that satisfy a particular criterion. The function f1(j,C1) is a function that estimates any increase or decrease in sales relative to the average sales volume b(j) due to a particular criterion C1 being satisfied. For example, f1(j,C1) may be an approximation (e.g. curve fit) of the data series (a(j)-b(j)), where a(j) is determined from executing the method 300 with the selection criteria corresponding to C1 as the one or more event selection criteria. C1 may be a binary value that is 1 if the criterion is satisfied and is otherwise 0. Likewise, the function f1(j,C1) may output zero for all inputs j where C1 is zero, i.e. have no effect on the estimated sales volume. The function f3(j,C3) . . . fD(j,CD) may be defined in a similar manner with respect to a different criterion, C3 through CD, where D is the number of criteria deemed to be statistically significant according to execution of the method 300.

The function V(j, C2, C3, . . . CD) may include terms of the form fab(j,Ca,Cb) that approximate an increase or decrease in sales relative to average sales b(j) for an event where two, three, or more selection criteria corresponding to Ca, Cb are simultaneously satisfied upon occurrence of an event. Specifically, the function fab(j,Ca,Cb) may approximate (a(j)-b(j)), where a(j) is obtained by executing the method 300 using the multiple criteria corresponding to Ca, Cb as the selection criteria at step 304. The function fab(j,Ca,Cb) will therefore be zero for all values j in the case where any of the selection criteria corresponding to Ca, Cb are not met.

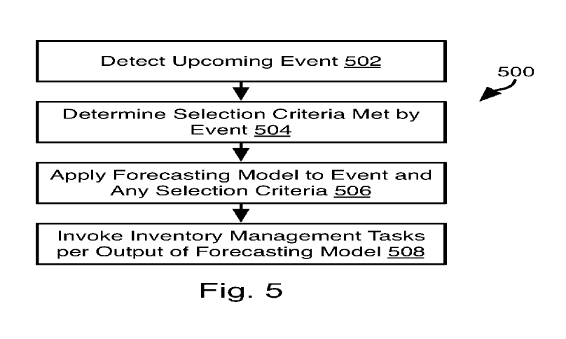

Referring to FIG. 5, method 500 is not merely comparative—method 500 is also predictive. Method 500 may be used to predict sales volume for a product, based on statistically significant correlations such as those formed at step 310 of method 300. The method 500 may be executed by the server system 102a. The method 500 may include detecting 502 an upcoming event.

Detecting an upcoming event can be conducted based on real-time data, upon static data, or upon a combination thereof, in various embodiments. Where the event is a regularly occurring holiday, for example, static data may be sufficient to detect the upcoming event without relying on real-time data by checking the event in a listing of holidays or an electronic representation of a calendar. Where the event is a sporting event, this may include receiving human input of the date of the sporting event or retrieving the date and name of the sporting event from a database 104c storing such information. Where the event is a weather event, step 502 may include receiving the estimated date and description of an event from a weather forecast in a database 104b. In embodiments, weather-related data can be real-time, such as a radar map, a regularly-updated forecast, or monitoring of damage or temperature reports in real-time.

In embodiments, predicted demand for a product can be based upon the stacked or combined impact of several events, some of which can be determined based on real-time data and some of which can be based upon static data. As an example, a store manager may wish to determine what products should be ordered in advance of Sunday, May 5. Events affecting sales on that day could include the fact that it is a holiday recognized in some areas, the fact that it is a Sunday (a day when sales tend to be higher), the timing of any nearby high school or college graduations, the upcoming Mothers' Day holiday, increases in temperature or other weather-related effects, pollen or mold spore count, or macroeconomic trends in the overall economy, among others. In one embodiment, method 500 includes detecting upcoming events 502 using a machine-learning or artificial intelligence program to scan the Internet or other electronic sources to learn about events in real time, such as monitoring satellite weather forecasts, news events, or other events which can affect sales.

The method 500 may further include determining 504 one or more selection criteria met by the event. For example, what day of the week is the event occurring on, what is the predicted weather for the event, or any other selection criteria mentioned herein or that may be perceived to attend the occurrence of an event. The forecasting model may then be applied 506 to the event using the one or more selection criteria. For example, where selection criteria corresponding to Cc and Cd are satisfied, the predicted sales volume for a date corresponding to position j 1 in a date window including the upcoming event, with the upcoming event being at the position in the window used during execution of the method 300, the predicted sales volume may be calculated as V=f0(j1)+f1(j1, Cc)+f3(j1,Cd) or V=f0(j1)+fcd(j1, Cc,Cd), for example

The method 500 may then include invoking 508 one or more inventory management tasks according to the output of the forecasting model. For example, where the predicted sales volume indicates a sales decline, then orders may be reduced or canceled in order to bring inventory available on that day closer to the expected sales volume. Likewise, where the predicted sales volume indicates a sales increase, additional inventory for the product may be automatically ordered in order to meet the expected demand.

In some embodiments, step 508 may include generating alerts (text messages, email, notifications within an inventory management application) that indicate to a human operator that an abnormally low or high sales volume is expected according to the forecasting model. In other embodiments, at 508 the method 500 can simply order needed supplies from a nearby distribution center.

As shown with respect to FIG. 4, these events, especially in combination, correlate to changes in actual sales volume of a particular product. Method 500 facilitates ordering a sufficient quantity of supplies to meet demand, but also prevents ordering too much of those supplies, and uses the window information to order those supplies at the correct time to prevent excess inventory.

For example, system 100 can accurately predict the demand for a particular product, based on detected events from static or real-time data. Using the Sunday, May 5 example, system 100 may determine that a particular store should stock more produce or other perishable groceries on May 4 due to an expected increase in sales of those items for the May 5 holiday event, as well as the weekend event. Similarly, system 100 may determine based on real-time weather data that gardening and pool supplies will be needed in larger quantities by approximately May 10, and will order or suggest ordering those items in advance of the May 10 date.

Conversely, system 100 may determine based upon the static data regarding weather from previous years and real-time data regarding weather this year that there is an over-supply of rock salt, shovels, and winter clothing, and suggest that orders for this type of inventory should be reduced or eliminated, or even that existing stock should be marked down.

Real-time data can be used to determine extremely short-term events, such as severe weather which can occur over the course of several hours. Although there may not be time to order additional inventory based upon this type of real-time data, nonetheless system 100 can make suggestions that will assist in efficient management at the store. For example, based upon flash flooding or a severe rain event, system 100 may suggest to a store manager that topstock or overstock of umbrellas and rain gear should be moved from those locations to the sales floor. Similarly, products could be moved to endcaps, checkout aisles, or the front of the store to match expected surges in demand based on such real-time data. In embodiments, the real-time data can be proactive, and suggest such redeployments of existing stock based upon, for example, flash flooding caused by a storm system that is expected to arrive at a store's location within a matter of hours.

Various modifications to the methods described above may be performed. For example, referring again to FIG. 5, the method 300 may be executed for each product of a plurality of products and may also be executed for a plurality of geographic regions or retail locations. Accordingly, the past sales analyzed at step 308 or used as the average sales b(j) may be those of the geographic region or specific retail location that is the subject of the method 300.

In some embodiments, the subset of events identified at step 306 may be selected both on the circumstances of the occurrence of the event (e.g. day of the week, weather, etc.) but also based on geography. Specifically, sales data for date windows including the event may be restricted to sales data for retail locations at locations satisfying one or more geographic criteria. For example, sales data for date windows including an event may be selected for retail locations meeting one or more geographic criteria such as proximity to a river, lake, or ocean; proximity to mountains, desert or snow; cultural or social factors that may be identified for a particular geographic location; or any other characteristic of a geographic location.

Other criteria that may be used to select events or as events themselves include economic factors or events, such as paydays, recessions, stock market corrections, interest rate adjustments by the Federal Reserve Bank, an unemployment rate, a labor participation rate, or any other economic metric.

The method 300 may be executed in a hierarchical manner. For example, one or more selection criteria may be identified as statistically significant at step 310 for a larger geographic region. The method 300 may then be executed with respect to sales and event data for smaller geographic regions, using only those selection criteria that are deemed statistically significant while ignoring those that were not deemed statistically significant. This process may be repeated for smaller and smaller geographic regions, with the possibility that selection criteria may be discarded for some geographic regions as not being statistically significant and therefore not being used during execution of the method 300 with respect to any sub regions of that geographic region.

In another example, the method 300 may be executed in a hierarchical manner with respect to selection criteria. For example, for a particular selection criteria, subsets of the selection criteria may be analyzed separately if the selection criteria is deemed statistically significant. For example, the occurrence a non-weekend day may be deemed to have an impact on sales. Accordingly, the impact of the event falling on Monday, Tuesday, Wednesday, and Friday may be analyzed separately. Likewise, for an extreme weather event such as snow, the impact of six inches of snow or more may be analyzed for its impact on sales for a particular event. If it is found to be significant, other ranges of snow fall (6 to 12, 12 to 18, etc.) may be analyzed separately. In a more general sense, selection criteria may be classified according to a taxonomy. Selection criteria may then be analyzed for higher-level nodes in the taxonomy with child nodes analyzed separately according to the method 300 if a parent node in the taxonomy is found 312 to have a statistically significant impact.

The events analyzed according to the methods disclosed herein may be discovered such that the impact of events that are not well known may be analyzed. Likewise, selection criteria may be discovered for analysis. The identification of events and selection criterion may be a human activity such that these are received by the server system 102a for processing according to the methods disclosed herein. In other events, automated web searches and data mining may be used to identify one or both of events and selection criteria, particularly for unplanned events where the selection criteria that might impact sales for the unplanned event are not known. Automated identification of events may be particularly helpful to discover local events or other special events and corresponding selection criteria that may not be well known to a large retailer. When an event is identified, it may be classified and then the server system 102a may search an event database for other events that have the same classification for analysis according to the method 300.

As noted above, the position of the events within the date windows may be at the beginning indicating that subsequent impact on sales will be analyzed. The events may also be located at the end of the date windows such that any impact on sales volume leading up to the event will be detected. In other implementations, the date windows include dates before and after each event such that the impact of the event as a leading or lagging indicator is analyzed. In particular, for events such as natural disasters, there may be some lead-time for people to prepare as well as a recovery period after the event. Accordingly, sales both before and after such events may be analyzed.

In some instances, rather than simply analyzing the impact of events and selection criteria on sales volume, the method 300 may be used to measure the impact of an event and one or more selection criteria on such things as personnel availability, product quality or availability, supply chain capacity, sourcing for one or more products, the shelf life of one or more products, other logistic factors, carrier availability and delivery times, equipment availability and functionality, product handling due to weather conditions, and other factors. Accordingly, any metric of one or more of these factors may be used in place of the sales volume and a forecasting model for one or more of these factors based on events and selection criteria may be generated and applied in the same manner as described above.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

What is claimed is:

1. A method for monitoring real-time data to manage inventory, the method comprising:
simultaneously monitoring a plurality of real-time data sources to detect an upcoming event;
matching the detected upcoming event to one or more categories;
retrieving, from a database, static data corresponding to each of the one or more categories that matches the detected upcoming event, the static data based upon sales data related to at least one past event;
stacking the retrieved static data from each of the matched categories to generate a forecast for the detected upcoming event; and
comparing the forecast and an existing inventory to generate a task with an inventory management module.

2. The method of claim 1, wherein stacking the retrieved static data to generate a forecast comprises:
identifying a first set of dates for which the static data corresponds to a first one of the one or more categories;
identifying a second set of N dates among the first set of dates for which the static data corresponds to a second one of the one or more categories that is different from the first one of the one ore more categories;
for each date d(i), i=1 to N, in the second set of N dates, defining a date window of M dates W(i,j), j=1 to M, including the date d(i);
for each position j=1 to M in the date window W(i,j), calculating an aggregate value A(j) as a function of sales data for at least one product on all dates W(i,j), i=1 to N; and
identifying a statistically significant sales trend in the aggregate values A(j), j=1 to M.

3. The method of claim 2, wherein the first one of the one or more categories is a holiday and the second one of the one or more categories is a particular day of the week.

4. The method of claim 2, wherein one of the first or second ones of the one or more categories is a weather condition.

5. The method of claim 2, wherein the first one of the one or more categories is a sporting event.

6. The method of claim 1, wherein the task comprises an instruction to modify a level of inventory of a product based upon an expected demand change caused by the detected event.

7. The method of claim 1, wherein the upcoming event is detected based upon both both real-time data monitoring and manual data entry.

8. The method of claim 1, wherein the task comprises reallocating inventory within a store.

9. The method of claim 1, wherein the one or more categories are each selected from the group consisting of:
a global event,
a national event,
a regional event,
a local event,
a regional condition,
a local condition,
a store event, and
a trend.

10. The method of claim 2, wherein the dates of the window W(i,j), j=1 to M corresponding to the date d(i) extends both before and after the date d(i).

11. The method of claim 2, wherein calculating an aggregate value A(j) as the function of the sales data for the at least one product on all dates W(i,j), i=1 to N comprises summing the sales data for the at least one product for all dates W(i,j), i=1 to N.

12. The method of claim 1, further comprising selecting the sales date for the at least one product comprises filtering the sales date according to a filtering criterion.

13. The method of claim 12, wherein the filtering criterion is a geographic criterion.

14. The method of claim 12, wherein the filtering criterion is a demographic criterion.

15. The method of claim 2, further comprising:
predicting sales for a future date according to the forecast; and
managing inventory for the at least one product in advance of the future date.

16. A system for monitoring real-time data to manage inventory comprising one or more processors and one or more memory devices coupled to the one or more processors, the one or more memory devices storing executable code effective to cause the one or more processors to:
simultaneously monitor a plurality of real-time data sources to detect an upcoming event;
match the detected event to one or more categories;
retrieve, from a database, static data corresponding to each of the one or more categories that matches the detected upcoming event, the static data based upon sales data related to at least one past event;
stack the retrieved static data from each of the matched categories to generate a forecast for the detected upcoming event; and
compare the forecast and an existing inventory to generate a task with an inventory management module.

17. The system of claim 16, wherein the system is configured to detect an upcoming event by:
identifying a first set of dates for which the static data corresponds to a first one of the one or more categories;
identifying a second set of N dates among the first set of dates for which the static data corresponds to a second one of the one or more categories that is different from the first one of the one ore more categories;
for each date d(i), i=1 to N, in the second set of N dates, defining a date window of M dates W(i,j), j=1 to M, including the date d(i);
for each position j=1 to M in the date window W(i,j), calculating an aggregate value A(j) as a function of sales data for at least one product on all dates W(i,j), i=1 to N; and
identifying a statistically significant sales trend in the aggregate values A(j), j=1 to M.

18. The method of claim 16, wherein the first one of the one or more categories is a sporting event and the second one of the one or more categories is a weather condition.

19. The system of claim 17, wherein the executable code is effective to cause the one or more processors to calculate an aggregate value A(j) as the function of the sales data for the at least one product on all dates W(i,j), i=1 to N by summing the sales data for the at least one product for all dates W(i,j), i=1 to N.

20. The system of claim 19, wherein the executable code is effective to cause the one or more processors to:
predict sales for a future date according to the statistically significant sales trend; and
manage inventory for the at least one product in advance of the future date.
